(19) United States
(12) Patent Application Publication
(10) Pub. No.: US 2015/0065297 A1
(43) Pub. Date: Mar. 5, 2015

(54) CONTROL DEVICE FOR HYBRID VEHICLE

(71) Applicant: Toyota Jidosha Kabushiki Kaisha, Toyota-shi Aichi-ken (JP)

(72) Inventors: Takeshi Hoshiba, Anjo-shi Aichi-ken (JP); Kenji Uchida, Nagoya-shi Aichi-ken (JP); Takeshi Aoki, Nishio-shi Aichi-ken (JP)

(21) Appl. No.: 14/468,960

(22) Filed: Aug. 26, 2014

(30) Foreign Application Priority Data
Aug. 28, 2013 (JP) 2013-177153

(51) Int. Cl. B60W 20/00; B60W 10/00; B60W 10/06; B60W 30/18; B60W 10/08

(52) U.S. Cl. CPC B60W 20/10; B60W 30/18009; B60W 10/08; B60W 10/06; B60W 10/00; Y10S 903/93
USPC 477/19; 180/65.265; 903/930

(57) ABSTRACT

In a first slip suppression control by a first slip suppression control unit when a vehicle stops on a slope, an electronic control unit controls an output torque of an electric motor so that a rotation speed of an input rotation member of a hydraulic power transmission reaches a predetermined target rotation speed during stopping of an engine. The electronic control unit starts the engine when the output torque of the electric motor is greater than a predetermined torque. Accordingly, when the output torque of the electric motor at a rotation speed under a slip suppression control is insufficient, the output torque of the engine can be used and thus a locked state of the electric motor is appropriately prevented.

### INCORPORATION BY REFERENCE

The disclosure of Japanese Patent Application No. 2013-177153 filed on Aug. 28, 2013 including the specification, drawings and abstract is incorporated herein by reference in its entirety.

### BACKGROUND OF THE INVENTION

1. Field of the Invention

The present invention relates to a control technique of suppressing slipping of a hybrid vehicle, which includes an engine and an electric motor as a drive source, on an uphill road.

2. Description of Related Art

A hybrid vehicle is well known which includes an engine, an electric motor, and a hydraulic power transmission that is disposed in a power transmission path between the engine and the electric motor and driving wheels so as to transmit dynamic power via a fluid. An example of such a hybrid vehicle is disclosed in Japanese Patent Application Publication No. 2000-308209 (JP 2000-308209 A).

### SUMMARY OF THE INVENTION

In such a hybrid vehicle, in order to prevent slipping of the vehicle which occurs at the time of changing an applied pressure from a brake pedal to an accelerator pedal to start the vehicle in stop on a slope having a road surface gradient, a state where a torque is transmitted to an axle and driving wheels is set up by causing the electric motor to rotate in advance. However, when the road surface gradient is relatively large and a pressure cannot be applied to the accelerator pedal just after the brake pedal is released, a slipping speed of the vehicle increases and the rotation speed of a pump wheel of the hydraulic power transmission decreases by the negative rotation of a turbine wheel of the hydraulic power transmission. In this way, when the rotation speed of the electric motor decreases and the electric motor is in a locked state where the rotation thereof is hindered, a drive current is limited by a protection circuit provided to protect the temperature of the electric motor. Accordingly, the torque may not be satisfactorily output from the electric motor and the vehicle may slip further.

The present invention provides a control device that can suppress slipping of a hybrid vehicle, which includes a hydraulic power transmission between an engine and an electric motor and driving wheels, on a slope and that can prevent a lock of the electric motor.

According to a first aspect of the present invention, a hybrid vehicle includes an engine, an electric motor, a hydraulic power transmission that is disposed between the engine and driving wheels, the hydraulic power transmission being disposed between the electric motor and the driving wheels, and an electronic control unit. The electronic control unit is configured to control an output torque of the electric motor so that a rotation speed of an input rotation member of the hydraulic power transmission reaches a predetermined target rotation speed during stopping of the engine. The electronic control unit is configured to start the engine when the output torque of the electric motor is greater than a predetermined torque.

According to this aspect, when the output torque of the electric motor at a rotation speed under a slip suppression control is insufficient, the output torque of the engine can be used. Accordingly, it is possible to satisfactorily suppress a slip on a slope and to appropriately prevent the electric motor from being in a locked state.

In the aspect, the electronic control unit may be configured to control an output torque of the engine so that the rotation speed of the input rotation member of the hydraulic power transmission reaches the target rotation speed, after the engine is started. According to this aspect, when the output torque of the electric motor at the rotation speed under the slip suppression control using only the output torque of the electric motor is insufficient, the slip suppression control is performed using the output torque of the engine. Accordingly, it is possible to satisfactorily suppress slipping on a slope.

In the aspect, the electronic control unit may be configured to increase the rotation speed of the engine using the output torque of the electric motor and to increase the output torque of the engine, when the output torque of the engine exceeds a maximum output torque of the engine at a current rotation speed of the engine. According to this aspect, when the output torque of the engine at the rotation speed under the slip suppression control using the output torque of the engine is insufficient, the rotation speed of the engine increases and thus the output torque of the engine increases by adding the output torque of the electric motor to the output torque of the engine. Accordingly, even when the output torque of the engine is insufficient, it is possible to satisfactorily suppress slipping on a slope.

In the aspect, the electronic control unit may be configured to set the target rotation speed based on a predetermined rotation speed of the input rotation member of the hydraulic power transmission corresponding to a target slipping speed and a predetermined rotation speed difference between the input rotation member of the hydraulic power transmission and an output rotation member of the hydraulic power transmission. According to the aspect, the rotation speed of the input rotation member of the hydraulic power transmission is controlled to reach the target rotation speed. Accordingly, slipping on a slope is satisfactorily maintained within the target slipping speed.

In the aspect, the electronic control unit may be configured to determine the rotation speed difference based on a road surface gradient on which the hybrid vehicle runs. According to this aspect, slipping on a slope is maintained within the target slipping speed regardless of the road surface gradient.

In the aspect, the electronic control unit may be configured to determine the rotation speed difference based on a relationship stored in advance so that the larger the road surface gradient on which the hybrid vehicle runs becomes, the larger the rotation speed difference becomes.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram illustrating a schematic configuration of a power transmission path from an engine and an electric motor, which constitute a hybrid vehicle to which the present invention is appropriately applied, to driving wheels along with a control system provided to the vehicle for an output control of the engine serving as a running drive source, a transmission control of an automatic transmission, a drive control of the electric motor, and the like;

FIG. 2 is a functional block diagram illustrating principal parts of a slip suppression control function by an electronic control unit illustrated in FIG. 1;

FIG. 3 is a diagram illustrating a method of setting a target rotation speed of the electric motor under a slip suppression control;

FIG. 4 is a diagram illustrating a method of setting an engine-start threshold value for determining whether to start the engine under the slip suppression control;

FIG. 5 is a diagram illustrating a method of setting a target rotation speed when the electric motor outputs a torque under the slip suppression control; and

FIG. 6 is a flowchart illustrating principal parts of the slip suppression control by the electronic control unit illustrated in FIG. 1, that is, control operations of the slip suppression control of the vehicle.

### DETAILED DESCRIPTION OF EMBODIMENTS

Hereinafter, an embodiment of the present invention will be described in detail with reference to the accompanying drawings. In the following embodiment, the drawings are appropriately simplified or deformed, and the dimensional ratios and the shapes of the constituents thereof are not accurately drawn.

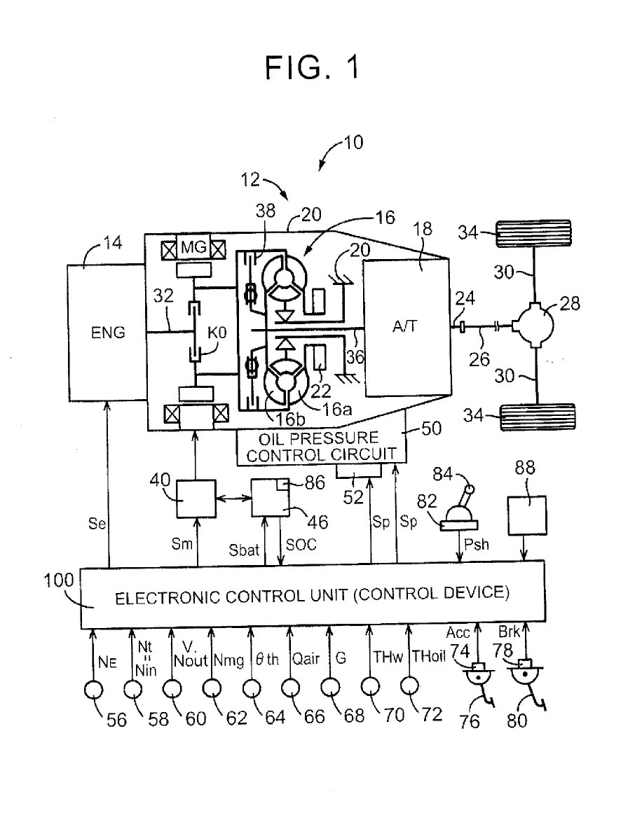

FIG. 1 is a diagram illustrating a schematic configuration of a power transmission path from an engine 14 and an electric motor MG to driving wheels 34, an engine 14 and an electric motor MG constituting a hybrid vehicle 10 (hereinafter, referred to as vehicle 10) to which the present invention is appropriately applied. FIG. 1 is also a diagram illustrating principal parts of a control system provided to the vehicle 10 for an output control of the engine 14 serving as a running drive source, a transmission control of an automatic transmission 18, a drive control of the electric motor MG, and the like.

In FIG. 1, a vehicle power transmission 12 (hereinafter, referred to as power transmission 12) includes an engine-coupling/decoupling clutch K0, an electric motor MG, a torque converter 16, an oil pump 22, and an automatic transmission 18 sequentially from an engine 14 side in a transmission case 20 (hereinafter, referred to as case 20). The transmission case 20 is a non-rotation member attached to a vehicle body by fastening with bolts or the like. The power transmission 12 includes a propeller shaft 26 connected to an output shaft 24 as an output rotation member of the automatic transmission 18, a differential gear 28 connected to the propeller shaft 26, and a pair of axles 30 connected to the differential gear 28. The power transmission 12 having this configuration is appropriately used, for example, in a front engine-rear drive (FR) type vehicle 10. In the power transmission 12, dynamic power of the engine 14 is transmitted from an engine-coupled shaft 32 to a pair of driving wheels 34 sequentially via the engine-coupling/decoupling clutch K0, the torque converter 16, the automatic transmission 18, the propeller shaft 26, the differential gear 28, and the pair of axles 30 when the engine-coupling/decoupling clutch K0 engages. The engine-coupled shaft 32 couples the engine 14 to the engine-coupling/decoupling clutch K0.

The torque converter 16 is a hydraulic power transmission that transmits a driving force input to a pump wheel 16a to the automatic transmission 18 via a fluid. The pump wheel 16a is connected to the engine 14 sequentially via the engine-coupling/decoupling clutch K0 and the engine-coupled shaft 32. The pump wheel 16a is an input rotation element to which the driving force is input from the engine 14 and that is rotatable about a shaft core. A turbine wheel 16b of the torque converter 16 is an output rotation element of the torque converter 16 and is connected to a transmission input shaft 36 as an input rotation member of the automatic transmission 18 so as not to be relatively rotatable by spline fitting or the like. The torque converter 16 includes a lockup clutch 38. The lockup clutch 38 is a direct coupling clutch disposed between the pump wheel 16a and the turbine wheel 16b. The lockup clutch 38 is switched to an engaged state, a slip state, or a disengaged state by an oil pressure control or the like.

The electric motor MG is, for example, a synchronous electric motor. The electric motor MG is, for example, a so-called motor-generator set having a function of a motor for generating a mechanical driving force from electric energy and a function of a power generator for generating electric energy from mechanical energy. In other words, the electric motor MG can serve as a running drive source for generating a running driving force instead of the engine 14 as a drive source or along with the engine 14. The electric motor MG generates electric energy from the driving force generated by the engine 14 or a driving force (mechanical energy) input from the driving wheels 34 side by regeneration. The electric motor MG performs an operation of accumulating the generated electric energy in a battery 46 as a power storage device via an inverter 40, a step-up converter not illustrated, and the like. The electric motor MG is operably connected to the pump wheel 16a and dynamic power is transmitted between the electric motor MG and the pump wheel 16a. Accordingly, the electric motor MG is connected to the transmission input shaft 36 so as to enable power transmission, similarly to the engine 14. The electric motor MG is connected to the battery 46 so as to give and receive electric power to and from the battery 46 via the inverter 40, the step-up converter not illustrated, and the like. When the vehicle runs using the electric motor MG as the running drive source, the engine-coupling/decoupling clutch K0 is disengaged. The dynamic power of the electric motor MG is transmitted to the pair of driving wheels 34 sequentially via the torque converter 16, the automatic transmission 18, the propeller shaft 26, the differential gear 28, the pair of axles 30, and the like.

The oil pump 22 is a mechanical oil pump that is connected to the pump wheel 16a and that is rotationally driven by the engine 14 (or the electric motor MG) to generate a working oil pressure for controlling a shift of the automatic transmission 18, controlling torque capacity of the lockup clutch 38, controlling engagement and disengagement of the engine-coupling/decoupling clutch K0, or supplying a lubricant to the elements of the power transmission path of the vehicle 10. The power transmission 12 also includes an electric oil pump 52 that is driven by an electric motor not illustrated. The electric oil pump 52 is supplementarily activated to generate an oil pressure, for example, when the oil pump 22 is not activated such as when the vehicle stops.

The engine-coupling/decoupling clutch K0 is a wet multi-disc hydraulic frictional engagement device in which plural friction plates superimposed on each other are pressed by a hydraulic actuator. The engine-coupling/decoupling clutch K0 is controlled in engagement and disengagement by an oil pressure control circuit 50 disposed in the power transmission 12 using an oil pressure generated by the oil pump 22 or the electric oil pump 52 as a source pressure. In the engagement and disengagement control, the engaging force of the engine-coupling/decoupling clutch K0 is, for example, continuously changed with the pressure control of a linear solenoid valve or the like in the oil pressure control circuit 50. In other words, the engaging force of the engine-coupling/decoupling clutch K0 may be referred to as power-transmissible torque capacity of the engine-coupling/decoupling clutch K0. The engine-coupling/decoupling clutch K0 includes a pair of clutch rotation members (a clutch hub and a clutch drum) that can relatively rotate in the disengaged state. One (the clutch hub) of the clutch rotation members is connected to the engine-coupled shaft 32 so as not to be relatively rotatable. The other (the clutch drum) of the clutch rotation members is connected to the pump wheel 16a of the torque converter 16 so as not to be relatively rotatable. By employing this configuration, the engine-coupling/decoupling clutch K0 causes the pump wheel 16a to rotate together with the engine 14 via the engine-coupled shaft 32. That is, in the engaged state of the engine-coupling/decoupling clutch K0, the driving force from the engine 14 is input to the pump wheel 16a. On the other hand, in the disengaged state of the engine-coupling/decoupling clutch K0, the dynamic power transmission between the pump wheel 16a and the engine 14 is intercepted. Since the electric motor MG is operably connected to the pump wheel 16a as described above, the engine-coupling/decoupling clutch K0 serves as a clutch that is disposed in the power transmission path between the engine 14 and the electric motor MG and that couples and decouples them. In the engine-coupling/decoupling clutch K0 of this embodiment, the torque capacity (engaging force) increases in proportion to the oil pressure. The engine-coupling/decoupling clutch K0 of this embodiment is in the disengaged state when an oil pressure is not supplied thereto. The engine-coupling/decoupling clutch K0 of this embodiment employs a so-called normally-open type clutch.

The automatic transmission 18 is connected to the electric motor MG so as to enable power transmission without passing through the engine-coupling/decoupling clutch K0. The automatic transmission 18 constitutes a part of the power transmission path from the engine 14 and the electric motor MG to the driving wheels 34. The automatic transmission 18 transmits dynamic power from the running drive source (the engine 14 and the electric motor MG) to the driving wheels 34 side. For example, the automatic transmission 18 is a planetary gear type multi-stage transmission serving as a stepped automatic transmission in which shifting of a gear stage is performed by switching any one of plural engagement devices, for example, hydraulic frictional engagement devices such as a clutch C and a brake B and plural gear stages (transmission stages) are selectively set up. The switching of any one of the hydraulic frictional engagement devices such as the clutch C and the brake B may be engagement and disengagement of the hydraulic frictional engagement devices. The automatic transmission 18 is a stepped transmission that performs a so-called clutch-to-clutch transmission which is often used in known vehicles, and changes the rotation of the transmission input shaft 36 and outputs the changed rotation from the output shaft 24. The transmission input shaft 36 is also a turbine shaft that is rotationally driven by the turbine wheel 16b of the torque converter 16. In the automatic transmission 18, a predetermined gear stage (shift stage) is set up depending on a driver's accelerator operation, the vehicle speed V, or the like by controlling the engagement and disengagement of the clutch C and the brake B. When both the clutch C and the brake B of the automatic transmission 18 are disengaged, a neutral state is achieved and thus the power transmission path between the driving wheels 34 and the engine 14 and the electric motor MG is intercepted. The automatic transmission 18 is an example of a transmission disposed in the power transmission path between the electric motor and the driving wheels in the present invention.

Referring back to FIG. 1, the vehicle 10 is provided with an electronic control unit 100 including, for example, a control device related to a hybrid drive control and the like. The electronic control unit 100 is constituted, for example, by a so-called microcomputer including a CPU, a RAM, a ROM, and an input and output interface. The CPU performs various controls on the vehicle 10 by processing signals in accordance with a program stored in advance in the ROM using a temporary memory function of the RAM. For example, the electronic control unit 100 is configured to perform an output control of the engine 14, a drive control of the electric motor MG including a regeneration control of the electric motor MG, a transmission control of the automatic transmission 18, a torque capacity control of the lockup clutch 38, a torque capacity control of the engine-coupling/decoupling clutch K0, and the like. The electronic control unit 100 is divided into an engine control section, an electric motor control section, and an oil pressure control (transmission control) section if necessary.

The electronic control unit 100 is supplied, for example, with a signal indicating an engine rotation speed Ne which is the rotation speed of the engine 14 detected by an engine rotation speed sensor 56. The electronic control unit 100 is supplied, for example, with a signal indicating the turbine rotation speed Nt of the torque converter 16 as the input rotation speed of the automatic transmission 18 detected by a turbine rotation speed sensor 58, that is, a transmission input rotation speed Nin which is the rotation speed of the transmission input shaft 36. The electronic control unit 100 is supplied, for example, with a signal indicating a transmission output rotation speed Nout which is the rotation speed of the output shaft 24 corresponding to the vehicle speed V or the rotation speed of the propeller shaft 26 as the vehicle speed-relevant value detected by an output rotation speed sensor 60. The electronic control unit 100 is supplied, for example, with a signal indicating a motor rotation speed Nmg which is the rotation speed of the electric motor MG detected by a motor rotation speed sensor 62. The electronic control unit 100 is supplied, for example, with a signal indicating a throttle valve opening θth which is a degree of opening of an electronic throttle valve (not illustrated) detected by a throttle sensor 64. The electronic control unit 100 is supplied, for example, with a signal indicating an amount of intake air Qair of the engine 14 detected by an intake air sensor 66. The electronic control unit 100 is supplied, for example, with a signal indicating a longitudinal acceleration G (or a longitudinal deceleration G) of the vehicle 10 detected by an acceleration sensor 68. The electronic control unit 100 is supplied, for example, with a signal indicating a coolant temperature THw of the engine 14 detected by a coolant temperature sensor 70. The electronic control unit 100 is supplied, for example, with a signal indicating a working oil temperature THoil of working oil in the oil pressure control circuit 50 detected by an oil temperature sensor 72. The electronic control unit 100 is supplied, for example, with a signal indicating an accelerator opening Acc which is a degree of operation of the accelerator pedal 76 as a driving force request quantity (driver-requested output) of the driver for the vehicle 10, which is detected by an accelerator opening sensor 74. The electronic control unit 100 is supplied, for example, with a signal indicating a brake pressure Brk which is a degree of operation of the brake pedal 80 as a braking force request quantity (driver-requested deceleration) of the driver for the vehicle 10, which is detected by a foot brake sensor 78. The electronic control unit 100 is supplied, for example, with a signal indicating a lever position (a shift operation position, a shift position, or an operation position) Psh of the shift lever 84 such as known “P”, “N”, “D”, “R”, and “S” positions detected by a shift position sensor 82. The electronic control unit 100 is supplied, for example, with a state of charge (charging capacity or remaining charging capacity) SOC of the battery 46 detected by a battery sensor 86 and the like. The electronic control unit 100 is supplied with electric power from an auxiliary battery 88 that is charged with power dropped by a DCDC converter not illustrated.

For example, an engine output control command signal Se for controlling the output of the engine 14 is output from the electronic control unit 100. For example, an electric motor control command signal Sm for controlling the operation of the electric motor MG is output from the electronic control unit 100. For example, an oil pressure command signal Sp or the like for activating an electromagnetic valve (solenoid valve) or the electric oil pump 52 included in the oil pressure control circuit 50 is output from the electronic control unit 100 so as to control the engine-coupling/decoupling clutch K0 or the oil pressure actuators of the clutch C and the brake B of the automatic transmission 18.

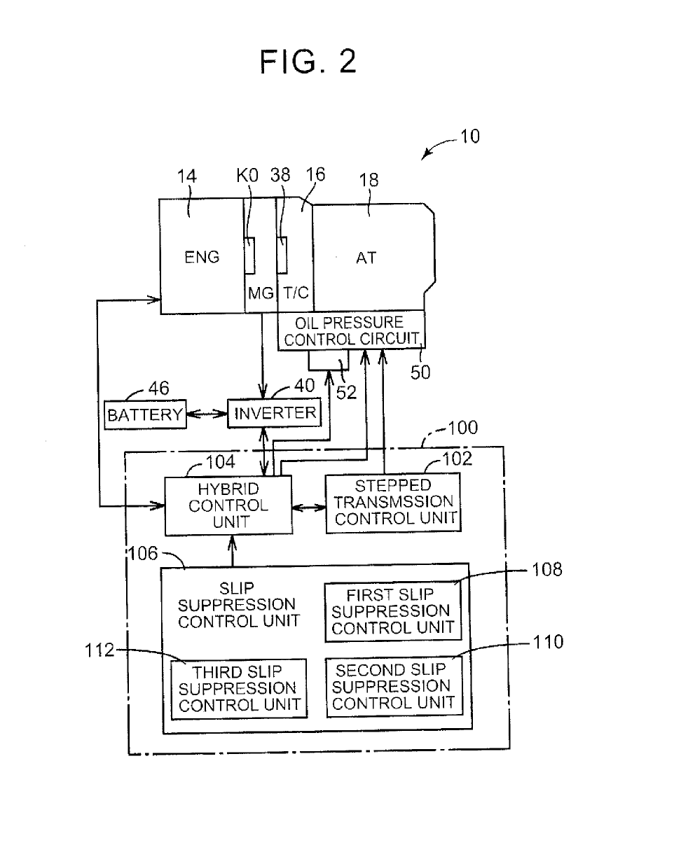

FIG. 2 is a functional block diagram illustrating principal parts of the control function of the electronic control unit 100. In FIG. 2, a stepped transmission control unit 102 (stepped transmission control means) serves as a gear shift control unit that performs the gear shift of the automatic transmission 18. The stepped transmission control unit 102 determines whether to perform the gear shift of the automatic transmission 18 based on the vehicle state indicted by the actual vehicle speed V and the accelerator opening Acc from the known relationship (gear shift diagram, gear shift map) having an up-shift line and a down-shift line stored in advance, for example, using the vehicle speed V and the accelerator opening Acc (or the transmission output torque Tout or the like) as parameters. That is, the stepped transmission, control unit 102 determines whether to shift the gear stage of the automatic transmission 18, and performs an automatic gear shift control of the automatic transmission 18 so as to set up the determined gear stage. The stepped transmission control unit 102 outputs a command Sp (a transmission output command, an oil pressure command) for causing the engagement device involved in the gear shift of the automatic transmission 18 to engage and/or to be disengaged to the oil pressure control circuit 50, for example, so as to achieve a gear stage based on a predetermined engagement operation table stored in advance.

A hybrid control unit 104 (hybrid control means) has a function of an engine drive control unit that controls driving of the engine 14 and a function of an electric motor operation control unit that controls the operation of the electric motor MG as a drive source or a power generator through the use of the inverter 40 controlling the electric motor MG, and performs a hybrid drive control using the engine 14 and the electric motor MG and the like by the control functions. For example, the hybrid control unit 104 calculates a vehicle request torque from the accelerator opening Ace or the vehicle speed V, and controls the running drive source so as to achieve the output torque of the running drive source (the engine 14 and the electric motor MG) with which the vehicle request torque is obtained in consideration of the transmission loss, the auxiliary device load, the gear stage of the automatic transmission 18, the state of charge SOC of the battery 46, and the like.

More specifically, for example, when the vehicle request torque is in a range which can be reached by only a motor torque Tmg (electric motor torque) of the electric motor MG, the hybrid control unit 104 sets a running mode to a motor-driven running mode (hereinafter, referred to as EV running mode) and performs motor-driven running (EV running) using the electric motor MG as a running drive source. When the EV running is performed, the hybrid control unit 104 disengages the engine-coupling/decoupling clutch K0 to intercept the power transmission path between the engine 14 and the torque converter 16 and outputs the motor torque Tmg necessary for the motor-driven running to the electric motor MG. At this time, the hybrid control unit 104 determines a gear stage in which the motor efficiency of the electric motor MG is the highest out of combinations of the operation states (the motor torque Tmg, the motor rotation speed Nmg) of the electric motor MG and the gear stages of the automatic transmission 18 in which the vehicle request driving force is obtained in the EV running, and outputs a command for shifting to the determined gear stage to the stepped transmission control unit 102.

The hybrid control unit 104 switches the running mode from the EV running mode to the engine-driven running mode, starts the engine 14, and performs the engine-driven running, for example, when the accelerator pedal 76 is pressed deeper to increase the vehicle request torque during the EV running and the motor torque Tmg necessary for the EV running corresponding to the vehicle request torque exceeds a predetermined EV running torque range in which the vehicle can perform the EV running, that is, when the vehicle request torque cannot be achieved without using at least the output torque (engine torque) Te of the engine 14. The hybrid control unit 104 transmits the engine-start torque Tmgs for starting the engine from the electric motor MG via the engine-coupling/decoupling clutch K0 to raise the rotation speed of the engine 14 while causing the engine-coupling/decoupling clutch K0 to engage toward the complete engagement at the time of starting the engine 14, and raises the engine rotation speed Ne to the rotation speed enabling a self-sustaining operation to control the ignition of the engine, the supply of a fuel, or the like, thereby starting the engine 14. Then, the hybrid control unit 104 causes the engine-coupling/decoupling clutch K0 to rapidly completely engage after the engine 14 is started. When the engine-driven running is performed, the hybrid control unit 104 causes the engine-coupling/decoupling clutch K0 to engage to transmit the driving force from the engine 14 to the pump wheel 16a, and outputs an assist torque to the electric motor MG if necessary. When the oil pump 22 is not activated such as when the vehicle stops, the hybrid control unit 104 supplementarily activates the electric oil pump 52 to prevent insufficiency of the working oil.

At the time of coast traveling (inertial traveling) with the accelerator turned off, braking by pressing the brake pedal 80, or the like, the hybrid control unit 104 has a function of the regeneration control means for rotationally driving the electric motor MG with the kinetic energy of the vehicle 10 to cause the electric motor MG to serve as a power generator, for the purpose of improvement of fuel efficiency, and charging the battery 46 with the electric energy via the inverter 40. The kinetic energy of the vehicle 10 is a reverse driving force transmitted from the driving wheels 34 to the engine 14 side. The regeneration control is performed so as to achieve an amount of power regenerated determined based on the state of charge SOC of the battery 46 or the braking force distribution of the braking force by an oil pressure brake for obtaining a braking force corresponding to the pressure applied to the brake pedal. In this embodiment, the hybrid control unit 104 causes the lockup clutch 38 to engage during regeneration-cost running.

When it is determined that the vehicle slips at the time of stopping of the vehicle, a slip suppression control unit 106 calculates a target rotation speed NP* of the pump wheel 16a, that is, the target rotation speed N_{MG}* (=N_{T}+ΔN) of the electric motor MG based on an actual rotation speed N_{T} (for example, a negative value of about −200 rpm) of the turbine wheel 16b, which is the output rotation element of the torque converter 16 and which corresponds to the target slipping speed VZ preset to about −2 km/h, and a rotation speed difference ΔN calculated in advance so that the larger the road surface gradient on which the vehicle runs becomes, the larger the rotation speed difference ΔN becomes so as to maintain the target slipping speed VZ. The slip suppression control unit 106 raises the actual rotation speed N_{P} of the pump wheel 16a, that is, the actual rotation speed N_{MG} of the electric motor MG, so as to be the target rotation speed N_{P}*, that is, the target rotation speed N_{MG}*. The slip suppression control unit 106 increases the torque transmitted to the driving wheels 34 via the torque converter 16 to increase the driving force of the driving wheels 34, thereby suppressing slipping of the vehicle. In brief, the target rotation speed N_{MG}* of the pump wheel 16a of the torque converter 16 is determined on the basis of the rotation speeds of the pump wheel 16a and the turbine wheel 16b of the torque converter 16 during the stopping of the engine.

The slip suppression control unit 106 includes a first slip suppression control unit 108 that increases the driving force of the driving wheels 34 using a feedback rotation speed control based on the output torque T_{MG} of the electric motor MG, a second slip suppression control unit 110 that increases the driving force of the driving wheels 34 using a feedback control based on the output torque T_{E} of the engine 14, and a third slip suppression control unit 112 that increases the driving force of the driving wheels 34 using a feedback rotation speed control based on the output torque T_{MG} of the electric motor MG and the output torque T_{E} of the engine 14.

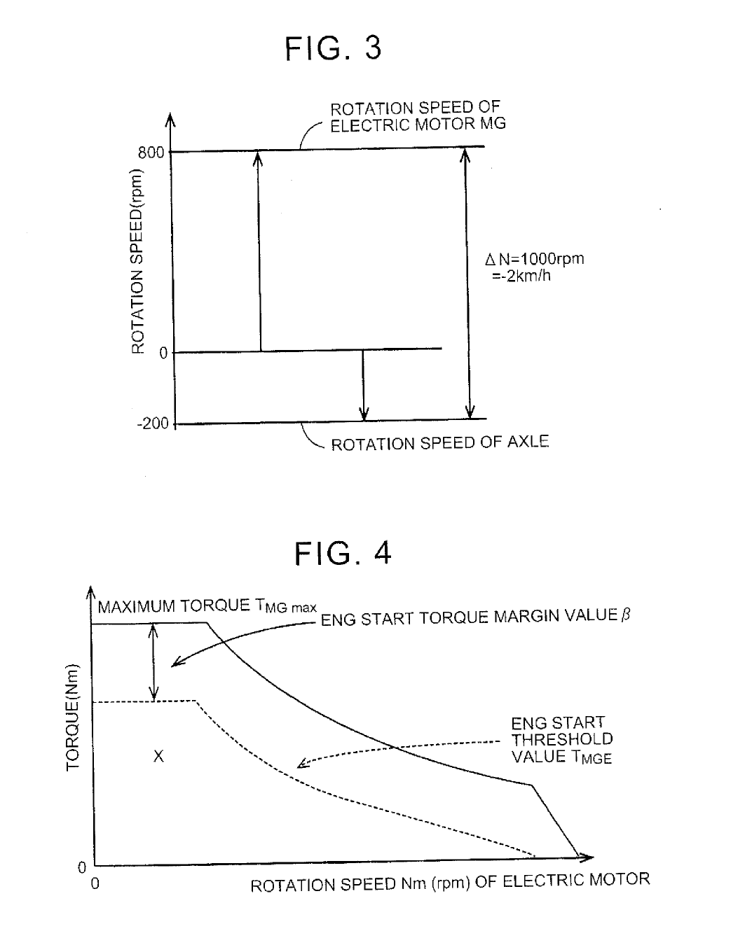

The first slip suppression control unit 108 performs the feedback rotation speed control by adjusting the output torque T_{MG} of the electric motor MG so that the actual rotation speed NP (=actual rotation speed N_{MG} of the electric motor MG) of the pump wheel 16a as the input rotation member of the torque converter 16 reaches a predetermined constant target rotation speed N_{P}* (=target rotation speed N_{MG}* of the electric motor MG) during the stopping of the engine 14. As illustrated in FIG. 3, when it is assumed that the rotation speed of the axle 30 (the driving wheels 34) at a slipping speed of the vehicle of, for example, −2 km/h is −200 rpm, and the rotation speed difference ΔN of the torque converter 16 generating a transmission torque to keep the rotation speed of the axle 30 constant at −200 rpm is 1000 rpm, the target rotation speed N_{P}* is set to 800 rpm. Since the rotation speed difference of the torque converter 16 generating a transmission torque to keep the rotation speed of the axle 30 constant at −200 rpm varies to a certain extent depending on the road surface gradient, the rotation speed difference ΔN of the torque converter 16 may be calculated on the basis of the actual gradient detected by an acceleration sensor or the like from a relationship stored in advance to be equal to a constant slipping speed of, for example, −2 km/h.

When the output torque T_{MG} of the electric motor MG at a current rotation speed of, for example, 800 rpm under the feedback control is greater than a predetermined engine-start threshold value T_{MGE} illustrated, for example, in FIG. 4 in the feedback rotation speed control based on the output torque T_{MG} of the electric motor MG by the first slip suppression control unit 108, the second slip suppression control unit 110 issues an engine start request to start the engine 14. After starting the engine 14, the second slip suppression control unit 110 starts the feedback control based on the output torque T_{E} of the engine 14 instead of the feedback rotation speed control using the electric motor MG. The second slip suppression control unit 110 performs the feedback rotation speed control by adjusting the output torque T_{E} of the engine 14 so that the actual rotation speed N_{P} (=actual rotation speed N_{MG} of the electric motor MG) of the pump wheel 16a as the input rotation member of the torque converter 16 reaches the target rotation speed N_{P}* calculated in advance to be a constant target slipping speed VZ of, for example, −2 km/h.

The engine-start threshold value T_{MGE} is set to a value lower by an engine-start torque margin value β than the maximum torque value T_{MGmax} of the electric motor MG at the current rotation speed of, for example, 800 rpm under the feedback control, for example, in the maximum torque characteristic diagram of the electric motor MG illustrating in FIG. 4. In FIG. 4, when the actual torque of the electric motor MG is defined as X and X>(TMGmax−β) is satisfied, the feedback control based on the output torque T_{E} of the engine 14 is started. That is, when the electric motor MG at the rotation speed under the feedback control requires an output torque equal to or greater than the engine-start threshold value T_{MGE} in the feedback control using the electric motor MG, the engine 14 is started.

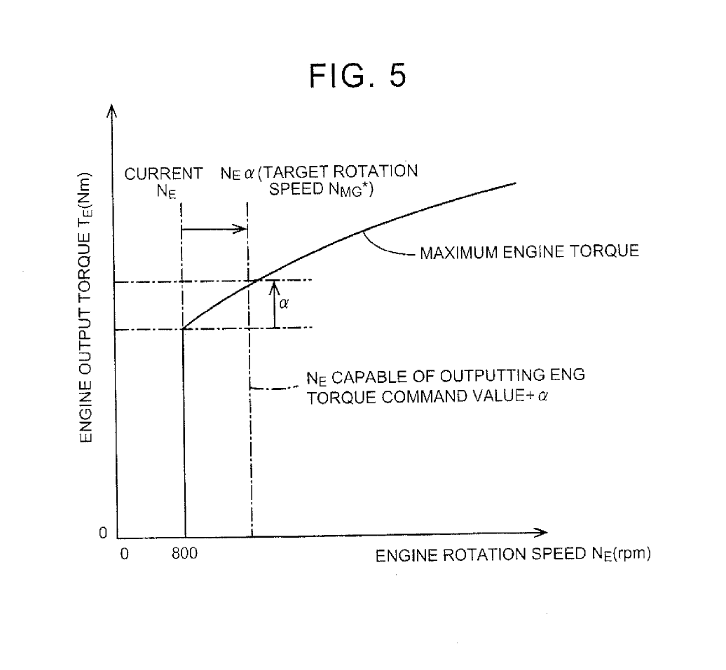

In the feedback rotation speed control based on the output torque T_{E} of the engine 14, when the output torque T_{E} of the engine 14 is greater than a predetermined threshold value T_{ES} in the vicinity of the maximum torque of the engine 14 at the current rotation speed of, for example, 800 rpm under the feedback control, the third slip suppression control unit 112 causes the electric motor MG to output the torque T_{MG}α while maintaining the torque command value for the engine 14. The third slip suppression control unit 112 performs the feedback control so that the actual rotation speed N_{P} (=actual rotation speed N_{MG} of the electric motor MG) of the pump wheel 16a as the input rotation member of the torque converter 16 reaches a target rotation speed N_{MGS}* calculated in advance to reach the constant target slipping speed VZ of, for example, −2 km/h. In order to match the actual rotation speed N_{P} (=actual rotation speed N_{MG} of the electric motor MG) of the pump wheel 16a with the target rotation speed N_{P}* calculated in advance to reach the constant target slipping speed of, for example, −2 km/h, when the maximum output torque of the engine 14 rotating at the current rotation speed of, for example, 800 rpm is insufficient by an insufficient torque α (when the output torque of the engine that performs the feedback control exceeds the maximum output torque of the engine at a current rotation speed of the engine), the slip suppression control unit 106 calculates the engine rotation speed N_{E}α increasing by the insufficient torque α on the basis of the value, which is obtained by adding the insufficient torque α of the output torque of the engine 14 to the actual output torque T_{E} of the engine 14, from the previously-stored engine characteristics illustrated in FIG. 5. the slip suppression control unit 106 sets the calculated value as the target rotation speed N_{MG}* of the electric motor MG. Accordingly, the torque T_{MG}α from the electric motor MG is added to the engine output torque T_{E} output from the engine 14 and the feedback control is continuously performed.

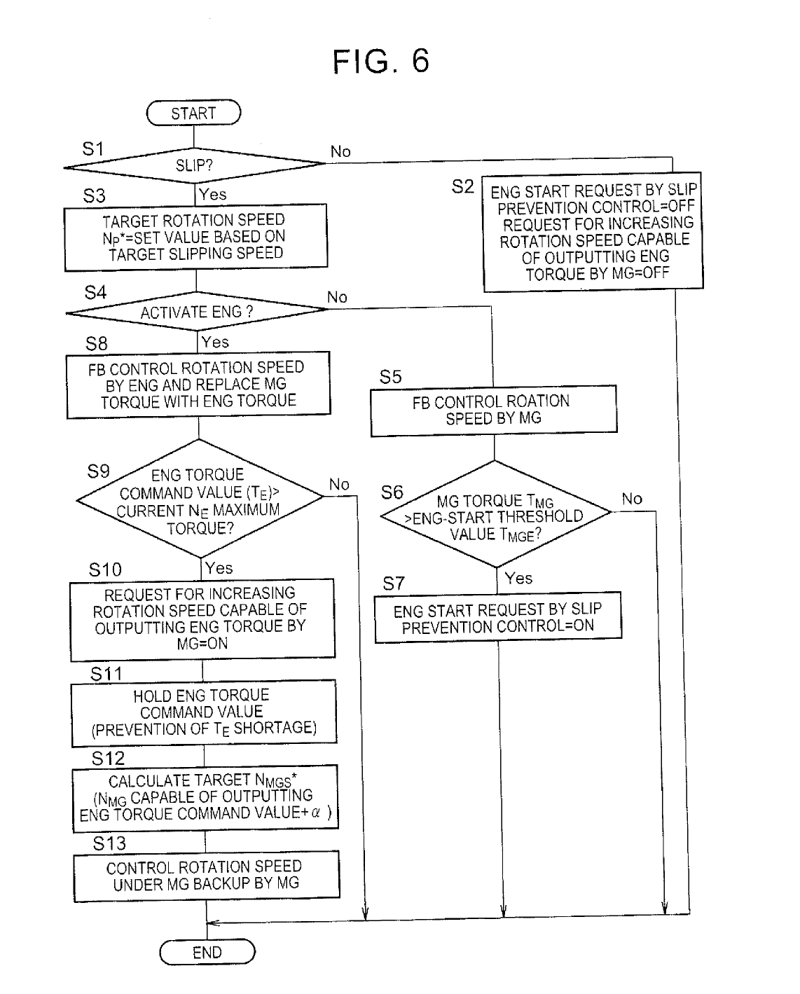

FIG. 6 is a flowchart illustrating principal parts of the control operation of the electronic control unit 100, that is, the control operation of the slip suppression control of suppressing slipping of the vehicle on a slope. The control operation of the slip suppression control of suppressing slipping of the vehicle on a slope is repeatedly performed, for example, with a very short cycle of several msec to several tens of msec.

In step S1 (hereinafter, step will be omitted) of FIG. 6, when the engine 14 is stopped, it is determined whether the vehicle slips on the basis of whether the pressure applied to the accelerator pedal is zero (accelerator off), the pressure applied to the brake pedal is zero (brake off), and the vehicle speed V in the D range is negative or the vehicle speed V in the R ranges is positive. When the determination result of S1 is negative, the engine start request based on the slip suppression control is stopped and the operation request of the electric motor MG for increasing the torque output rotation speed of the engine 14 by the use of the electric motor MG is stopped in S2.

When it is determined that the vehicle slips at the time of the stopping of the vehicle, the determination result of S1 is positive. The target rotation speed N_{P}* of the pump wheel 16a, that is, the target rotation speed N_{MG}* (=N_{T}+ΔN) of the electric motor MG, is calculated in S3 on the basis of the actual rotation speed N_{T} (for example, a negative value of about −200 rpm) of the turbine wheel 16b as the output rotation member of the torque converter 16 corresponding to the target slipping speed VZ of, for example, about −2 km/h and the rotation speed difference ΔN between the rotation speed N_{P} of the pump wheel 16a of the torque converter 16 calculated in advance for maintaining the target slipping speed VZ and the rotation speed N_{T} of the turbine wheel 16b.

Subsequently, in S4, whether the engine 14 is in operation is determined on the basis of whether the engine rotation speed N_{E} is zero. When the determination result of S4 is negative, the first slip suppression control described with reference to the first slip suppression control unit 108, that is, the feedback rotation speed control of adjusting the output torque T_{MG} of the electric motor MG so that the actual rotation speed NP (=actual rotation speed NMG of the electric motor MG) of the pump wheel 16a as the input rotation member of the torque converter 16 reaches the constant target rotation speed NP* (=target rotation speed NMG* of the electric motor MG), is performed in S5 corresponding to the first slip suppression control unit 108.

In S6, it is determined whether the output torque TMG of the electric motor MG at the current rotation speed of, for example, 800 rpm under the first slip suppression control is greater than the predetermined engine-start threshold value T_{MGE} illustrated, for example, in FIG. 4. When the determination result of S6 is negative, the routine up to now is repeated and the first slip suppression control is continuously performed.

On the other hand, when the determination result of S6 is positive, a start request command of the engine 14 is issued to perform the second slip suppression control in S7 and the engine 14 is started. Accordingly, the determination result of S4 in a next control cycle is positive.

In S8 which is performed subsequently to the positive determination of S4 and which corresponds to the second slip suppression control unit 110, the second slip suppression control is performed instead of the feedback rotation speed control using the electric motor MG as the first slip suppression control. The feedback control using the output torque T_{E} of the engine 14 is started, and the feedback rotation speed control is performed by adjusting the output torque T_{E} of the engine 14 so that the actual rotation speed N_{P} (=actual rotation speed N_{MG} of the electric motor MG) of the pump wheel 16a as the input rotation member of the torque converter 16 reaches the target rotation speed N_{P}* calculated in advance to be the constant target slipping speed VZ of, for example, −2 km/h.

Subsequently, in S9, it is determined whether the engine torque command value indicating the output torque of the engine 14 under the second slip suppression control is greater than the maximum torque of the engine 14 at the current rotation speed. That is, in the second slip suppression control, whether the maximum output torque of the engine 14 rotating at the current rotation speed of, for example, 800 rpm is insufficient by an insufficient torque a so as to match the actual rotation speed N_{P} (=actual rotation speed N_{MG} of the electric motor MG) of the pump wheel 16a with the target rotation speed N_{P}* calculated in advance to be the constant slipping speed of, for example, −2 km/h.

When the determination result of S9 is negative, the second slip suppression control is continuously performed instead of the routine performed up to now. On the other hand, when the determination result of S9 is positive, a request command for increasing the torque output rotation speed of the engine 14 using the electric motor MG is issued to perform the third slip suppression control in S10. The torque command value for the engine 14 is maintained so as to prevent transient shortage output torque of the engine 14 at the time of starting the increase in the engine output rotation speed using the electric motor MG in S11.

Subsequently, S12 and S13 corresponding to the third slip suppression control unit 112 are performed. In S12, the engine rotation speed N_{E}α increasing by the insufficient torque α is calculated on the basis of the value obtained by adding the insufficient torque α of the output torque of the engine 14 to the actual output torque T_{E} of the engine 14, for example, from the previously-stored engine characteristics illustrated in FIG. 5. The calculated value is set as the target rotation speed N_{MGS}* of the electric motor MG. Subsequently, in S13, when the output torque T_{E} of the engine 14 is greater than a predetermined threshold value T_{ES} in the vicinity of the maximum torque of the engine 14 at the current rotation speed of, for example, 800 rpm under the feedback control in the feedback rotation speed control (second slip suppression control) using the output torque T_{E} of the engine 14, the torque T_{MG}α is output from the electric motor MG while maintaining the torque command value for the engine 14 up to now. The feedback control, that is, the third slip suppression control, is performed so that the actual rotation speed N_{P} (=actual rotation speed N_{MG} of the electric motor MG) of the pump wheel 16a as the input rotation member of the torque converter 16 reaches the target rotation speed N_{MGS}* calculated in advance to correspond to the constant target slipping speed VZ of, for example, −2 km/h.

As described above, according to this embodiment, when the vehicle stops in a slope, the output torque of the electric motor MG is controlled so that the rotation speed N_{P} of the pump wheel (input rotation member) 16a of the torque converter 16 (hydraulic power transmission), that is, the rotation speed N_{MG} of the electric motor MG, reaches the target rotation speed N_{MG}* in the first slip suppression control by the first slip suppression control unit 108. Then, When the torque necessary for matching the rotation speed N_{P} of the pump wheel 16a of the torque converter 16 with the target rotation speed N_{MG}* is greater than a predetermined torque, the engine 14 is started. Accordingly, when the output torque of the electric motor MG at the rotation speed under the slip suppression control is insufficient, the output torque of the engine 14 can be used and thus the electric motor MG is appropriately prevented from being in the locked state.

According to this embodiment, after the engine 14 is started, the second slip suppression control by the second slip suppression control unit 110 is started and the output torque of the engine 14 is controlled so that the rotation speed N_{P} of the pump wheel 16a of the torque converter 16 reaches the target rotation speed N_{MG}*. Accordingly, the output torque of the engine 14 is controlled so that the rotation speed N_{P} of the pump wheel 16a of the torque converter 16 reaches the target rotation speed N_{MG}*. As a result, when the output torque of the electric motor MG at the rotation speed under the slip suppression control using only the output torque of the electric motor MG is insufficient, the slip suppression control is performed using the output torque of the engine 14 and thus the slip in the slope is continuously suppressed.

According to this embodiment, when the output torque of the engine 14 at the rotation sped under the second slip suppression control using only the output torque of the engine 14 after the engine 14 is started is insufficient, the third slip suppression control by the third slip suppression control unit 112 is started. When the third slip suppression control is started, the rotation speed of the engine 14 increases and the thus the output torque of the engine increases, by adding the output torque of the electric motor MG to the output torque of the engine 14. Accordingly, even when the output torque of the engine is insufficient the slip in the slope is suppressed. The electric motor MG adds the torque so that the rotation speed of the engine 14 reaches the rotation speed at which the torque from the engine 14 can be satisfactorily output. Accordingly, the engine 14 rotates at the rotation speed at which the torque from the engine 14 can be satisfactorily output. As a result, a sufficient output torque is output from the engine 14 and thus the slipping of the vehicle is suppressed.

According to this embodiment, the target rotation speed N_{MG}* is set on the basis of the rotation speed N_{P} of the pump wheel 16a of the torque converter 16 determined in advance to correspond to the target slipping speed VZ and the predetermined rotation speed difference ΔN of the torque converter 16. In this way, the target rotation speed NMG* is set on the basis of the rotation speed difference ΔN of the torque converter 16 determined in advance to maintain the target slipping speed VZ. Accordingly, by performing the control so that the rotation speed N_{P} of the pump wheel 16a of the torque converter 16 reaches the target rotation speed N_{MG}*, the slipping on the slope is maintained at the target slipping speed VZ.

According to this embodiment, in the slip suppression control unit 106, the rotation speed difference ΔN used to set the target rotation speed N_{MG}* is determined on the basis of the actual road surface gradient on which the vehicle runs from the relationship stored in advance so that the larger the road surface gradient on which the vehicle runs becomes, the larger the target rotation speed N_{MG}* becomes. Accordingly, the slipping on the slope is maintained at the target slipping speed VZ regardless of the road surface gradient.

The embodiment of the present invention has been described in detail with reference to the accompanying drawings. The present invention may be embodied in other aspects.

For example, in the above-mentioned embodiment, the target rotation speed N_{MG}* is set by adding the predetermined rotation speed difference ΔN, for example, +1000 rpm, of the torque converter 16 to the rotation speed N_{P} of, for example, −200 rpm, of the pump wheel 16a of the torque converter 16 determined in advance to correspond to the target slipping speed VZ. The target slipping speed VZ and the rotation speed difference ΔN may employ fixed values depending on vehicles. The target rotation speed N_{MG}* may be a fixed value stored in advance.

The hybrid vehicle according to the above-mentioned embodiment is equipped with the torque converter 16 as the hydraulic power transmission. A fluid coupling serving as the hydraulic power transmission may be provided instead of, the torque converter 16.

The slip suppression control of the above-mentioned embodiment is applied to an uphill road. The slip suppression control of the above-mentioned embodiment may be applied to a downhill road.

In the flowchart of the above-mentioned embodiment, the order of steps may be appropriately changed without causing any contradiction. For example, in the flowchart illustrated in FIG. 6, steps S3 and S4 may be performed reversely.

The automatic transmission 18 of the above-mentioned embodiment is a stepped automatic transmission. The specific structure or the number of transmission stages of the transmission is not particularly limited.

In the above-mentioned embodiment, the engine-coupling/decoupling clutch K0 is disposed between the engine 14 and the electric motor MG. However, the engine-coupling/decoupling clutch K0 may not be provided necessarily.

The above-mentioned embodiment is only an example, and the present invention can be modified and improved in various aspects on the basis of knowledge of those skilled in the art.

What is claimed is:

1. A hybrid vehicle comprising:
an engine;
an electric motor;
a hydraulic power transmission that is disposed between the engine and driving wheels, the hydraulic power transmission being disposed between the electric motor and the driving wheels; and
an electronic control unit configured to
(a) control an output torque of the electric motor so that a rotation speed of an input rotation member of the hydraulic power transmission reaches a predetermined target rotation speed during stopping of the engine, and
(b) start the engine when the output torque of the electric motor is greater than a predetermined torque.

2. The hybrid vehicle according to claim 1, wherein
the electronic control unit is configured to control an output torque of the engine so that the rotation speed of the input rotation member of the hydraulic power transmission reaches the target rotation speed, after the engine is started.

3. The hybrid vehicle according to claim 2, wherein
the electronic control unit is configured to increase the rotation speed of the engine using the output torque of the electric motor and to increase the output torque of the engine, when the output torque of the engine exceeds a maximum output torque of the engine at a current rotation speed of the engine.

4. The hybrid vehicle according to claim 1, wherein
the electronic control unit is configured to set the target rotation speed based on a predetermined rotation speed of the input rotation member of the hydraulic power transmission corresponding to a target slipping speed and a predetermined rotation speed difference between the input rotation member of the hydraulic power transmission and an output rotation member of the hydraulic power transmission.

5. The hybrid vehicle according to claim 4, wherein
the electronic control unit is configured to determine the rotation speed difference based on a road surface gradient on which the hybrid vehicle runs.

6. The hybrid vehicle according to claim 5, wherein
the electronic control unit is configured to determine the rotation speed difference based on a relationship stored in advance, so that the larger the road surface gradient on which the hybrid vehicle runs becomes, the larger the rotation speed difference becomes.
